(19) United States
(12) Patent Application Publication
(10) Pub. No.: US 2005/0109844 A1
(43) Pub. Date: May 26, 2005

(54) Universal product code conversion to electronic product code

(75) Inventor: Nick Hilliard, Dublin (IE)

Correspondence Address: JUSTIN GRAY, 12003 WALNUT BRANCH RD., RESTON, VA, 20194, US

(73) Assignee: ALYSIS INTERACTIVE CORPORATION, San Francisco, CA (US)

(21) Appl. No.: 10/707,216

(22) Filed: Nov. 26, 2003

(51) Int. Cl. G06K 15/00

(52) U.S. Cl. 235/383

(57) ABSTRACT

A method and apparatus for converting or translating descriptions of products encoded in the Universal Product Code (UPC) or Uniform Code Council 12 (UCC-12) format to the Electronic Product Code (EPC) format.

### BACKGROUND OF INVENTION

This invention relates to a method and apparatus for converting or translating descriptions of products encoded in the Universal Product Code (UPC) or Uniform Code Council 12 (UCC-12) format to the Electronic Product Code (EPC) format.

Radio Frequency ID (RFID) systems allow for the identification of objects at a distance and out of line of sight. They are comprised of RFID tags and readers. The tags are smaller, sometimes as small as a grain of rice, less expensive than readers, and are commonly attached to objects such as product packages in stores. When a reader comes within range of an RFID tag, it may provide power to the tag via a querying signal, or the RFID tag may use stored power from a battery or capacitor to send a radio frequency signal to be read by the RFID reader.

Retailers and automated toll collection systems have used RFID systems for years to ensure payment. Now with the impetus provided by the world's largest retailer and the United States' Department of Defense, RFID systems are poised for widespread adoption and standardization by manufacturers and distributors. Both organizations have directed their suppliers to adopt the technology by 2005. Manufacturers and distributors using UCC-12 format to identify their products will need to translate their product codes to EPC format for embedding in RFID tags. Because UPC is widely used, on-the-fly conversion between codes will be used for at least several years as companies move to the new EPC format. Low complexity methods will allow for rapid translation between the two standards.

U.S. Pat. No. 5,557,092 discloses an apparatus and method for 16-bit and numeric data collection using bar code symbologies. The system does convert between symbologies, but its output is to bar code, a different stage of the commercial item processing pipeline than this invention. The system also differs in its approach to code conversion and does not support the EPC code. U.S. Pat. No. 5,675,137 discloses a bar code decoding using moving averages to break the (n,k) code barrier for UPC, EAN Code 128 and others. Like this invention, it has application to several commercial symbologies, but is a preprocessing system designed to extract the code values from bar codes, rather than to convert between symbologies. U.S. Pat. No. 6,012,638 discloses a machine-readable symbology and method and apparatus for printing and reading same. It differs from this invention in that it deals with a machine readable symbology rather than the conversion between two symbologies used for categorizing items for trade. U.S. Pat. No. 6,597,465 discloses a method for mode detection and conversion for printers and tag interrogators. The method operates on bar codes and does not support conversion from the UPC format to the EPC format. It does not specify the precise steps of computation to be performed.

### SUMMARY OF INVENTION

This invention is a method and apparatus for converting or translating descriptions of products encoded in the Universal Product Code (UPC) or Uniform Code Council 12 (UCC-12) format to the Electronic Product Code (EPC) format. The invention represents a new methodology for creating EPC codes from UPC/UCC-12 codes. The method operates on valid existing UPC/UCC-12 codes and object types and produces valid EPC codes as output. The preferred embodiments are presented as sets of C-Language and Intel Architecture assembly language instructions, but a hardware implementation via digital logic could easily be constructed from the method revealed by the preferred embodiments. The foregoing general description and the following detailed description are exemplary and explanatory only and do not restrict the claims directed to the invention. The accompanying drawings, which are incorporated in and constitute a part of this specification, illustrate one embodiment of the invention and together with the description, serve to explain the principles of the invention.

### BRIEF DESCRIPTION OF DRAWINGS

FIG. 1 is a flow chart illustrating the method of conversion.

### DETAILED DESCRIPTION

The following detailed description of the preferred embodiment of this invention and the attached figures are intended to provide a clear description of the invention without limiting its scope.

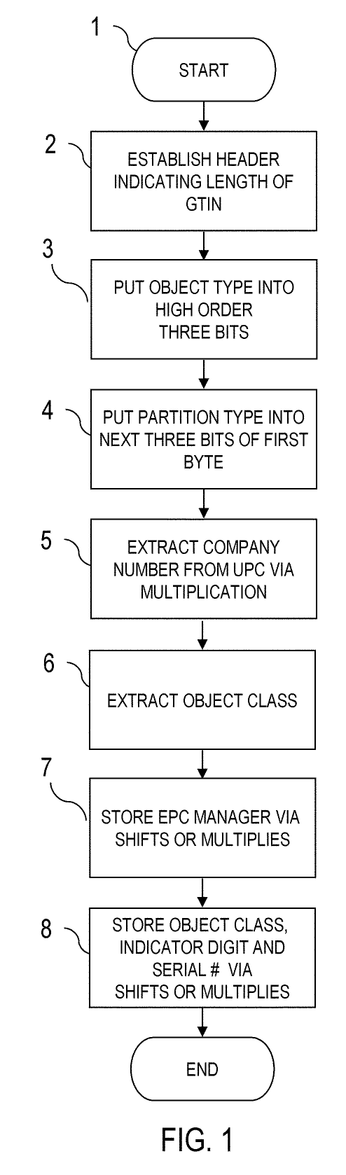

FIG. 1 is a flow chart illustrating the method of conversion. At start, 1, the UPC code has been loaded into a register or registers or range of memory in preparation for conversion to an EPC code. In 2, the first portion of the EPC code is stored into the registers or memory area representing the high order byte. This information holds the code for the header indicating length of the GTIN or Global Trade Item Number. In 3, the object type is stored in the high-order three bits of the next available word. In 4, the partition type is stored in the next three bits of storage space of the growing EPC code result. In 5, the company number is extracted from the UPC via multiplication and subtraction. In 6, the object class is similarly extracted. In 7, the extracted EPC Manager number is stored via shifts or multiply operations, followed by writes to the appropriate register or memory range used to store the growing EPC code result. In 8, the object class and indicator digit are stored via shifts or multiply operations, followed by writes to the appropriate register or memory range used to store the growing EPC code result.

Source Code Implementation The following Appendix A is a source code listing illustrating program logic for conversion between formats in accordance with the present invention. A suitable C/C++ compiler for compiling the source code is available from a variety of vendors, including Microsoft of Redmond, Wash., Borland International of Scotts Valley, Calif. and the Free Software Foundation of Boston, Mass. The following Appendix B is a source code listing illustrating program logic for conversion between formats in accordance with the present invention. A suitable 32-bit-Intel-Architecture (IA32 or X86) compiler for compiling the source code is available from a variety of vendors, including Microsoft of Redmond, Wash., Borland International of Scotts Valley, Calif. and the Free Software Foundation of Boston, Mass.

A person skilled in the art will be able to reorder the instructions in the following code listing or substitute some instructions for others to generate similar results. For instance, the values to be stored within the EPC memory area could be generated by performing mathematical operations on a single floating point number within a floating point register and then converting the floating point value to an integer for storage. Similarly a Hamiltonian or other matrix operation could transform the space of UPC numbers to EPC numbers of the format specified herein. An alternative embodiment would employ the bitfield library of a language to store the results of the arithmetic operations used to extract and assemble the code. The code provided could similarly be processed to serve as the template for a silicon compiler or could be implemented by the assembly of the appropriate digital logic integrated circuits. The code could also be compiled for other computer system architectures and processors. The intention of the included source code is to present multiple working implementations of the code to provide clear examples of embodiments and to further illustrate how the method and apparatus operate without limiting the scope of the invention.

APPENDIX A: C-Language Code// UPC to EPC conversion code, based on multiplication, division, and shiftingvoid UPC2EPC1(_{——}int64 UPC, unsigned char header, unsigned char partition, unsigned char objectType, unsigned char indicatorDigit, unsigned char* EPC, unsigned char* serial-Number) {unsigned long EPCMgr; unsigned long Object-Class; EPC[0]=header;// header indicates 96-bit GTINEPC[1]=objectType<<5;// move objectType into high-order three bits EPC[1]|=partition<<2;// move partition type into next three bitsEPCMgr=(unsigned long)(UPC/1000000);// extract company number/EPC manager number// extract object class, discard check digitObjectClass=(unsigned long)(UPC-(_{——}int64)EPCMgr*1000000)/10; EPC[2]=(unsigned char)(EPCMgr>>14);// shift and incorporate high bitsEPC[3]=(unsigned char)(EPCMgr>>6);// shift and incorporate next bitsEPC[4]=(unsigned char)(EPCMgr<<2);// shift and incorporate next bitsObjectClass +=indicatorDigit*100000; EPC[5]=(unsigned char)(ObjectClass>>10);// shift and incorporate high bit-sEPC[6]=(unsigned char)(ObjectClass>>2);// shift and incorporate next bitsEPC[7]=(unsigned char)(ObjectClass <<6);// shift and incorporate last bitsEPC[7]|=serialNumber[0];// bits are already alignedEPC[8]=serialNumber[1];// bits are already alignedEPC[9]=serialNumber[2];// bits are already alignedEPC[10]=serialNumber[3];// bits are already alignedEPC[11]=serialNumber[4];// bits are already aligned}APPENDIX B: C-Language Code// UPC to EPC conversion code, based on multiplication and divisionvoid UPC2EPC2(_{——}int64 UPC, unsigned char header, unsigned char partition, unsigned char objectType, unsigned char indicatorDigit, unsigned char* EPC, unsigned char* serialNumber) {unsigned long EPCMgr; unsigned long ObjectClass; EPC[0]=header;// header indicates 96-bit GTINEPC[1]=objectType <<5;// move objectType into high-order three bits EPC[1]|=partition <<2;// move partition type into next three bit-sEPCMgr=(unsigned long)(UPC/1000000);// extract company number/EPC manager number// extract object class, discard check digitObjectClass=(unsigned long)(UPC−(_{——}int64)EPCMgr*1000000)/10; EPC[2]=(unsigned char)(EPCMgr/16384);// shift and incorporate high bitsEPC[3]=(unsigned char)(EPCMgr/64);// shift and incorporate next bitsEPC[4]=(unsigned char)(EPCMgr*4);// shift and incorporate next bitsObjectClass +=indicatorDigit*100000; EPC[5]=(unsigned char)(ObjectClass/1024);// shift and incorporate high bitsEPC[6]=(unsigned char)(ObjectClass/4);// shift and incorporate next bitsEPC[7]=(unsigned char)(ObjectClass*64);// shift and incorporate last bitsEPC[7]|=serialNumber[0];// bits are already alignedEPC[8]=serialNumber[1];// bits are already alignedEPC[9]=serialNumber[2];// bits are already alignedEPC[10]=serialNumber[3];// bits are already alignedEPC[11]=serialNumber[4];// bits are already aligned}APPENDIX C: Intel-Architecture Assembly Code// First, sample code of calling procedure for function lea eax, [serialNumber] push eax lea eax, [EPC] push eax push 1 push 3 push 5 push 10h push 12h push 556A9CD8h call UPC2EPC1// Now actual function to convertUPC2EPC: push ebp mov ebp, esp sub esp, 0D8h push ebx push esi push edi lea edi[ebp-0D8h] push 36h pop ecx mov eax, 0CCCCCCCCh rep stos dword ptr [edi] 8: unsigned long EPCMgr; 9: unsigned long ObjectClass;// header indicates 96-bit GTIN mov eax, dword ptr [EPC] mov cl, byte ptr [header] mov byte ptr [eax], cl // move objectType into high-order three bits movzx eax, byte ptr [objectType] shl eax, 5 mov ecx, dword ptr [EPC] mov byte ptr [ecx+1], al // move partition type into next three bits movzx eax, byte ptr [partition] shl eax, 2 mov ecx, dword ptr [EPC] movzx ecx, byte ptr [ecx+1] or ecx, eax mov eax, dword ptr [EPC] mov byte ptr [eax+1], cl // extract company number/EPC manager number push 0 push 0F4240h push dword ptr [ebp+0Ch] push dword ptr [UPC] call @ILT+340(_{——}alldiv) (411159h) mov dword ptr [EPCMgr], eax // extract object class, discard check digit mov eax, dword ptr [EPCMgr] mov ecx, 0F4240h mul eax, ecx mov ecx, dword ptr [UPC] sub ecx, eax mov eax, dword ptr [ebp+0Ch] sbb eax, edx mov eax, ecx xor edx, edx push 0Ah pop ecx div eax, ecx mov dword ptr [ObjectClass], eax // shift and incorporate high bits mov eax, dword ptr [EPCMgr] shr eax, 0Eh mov ecx, dword ptr [EPC] mov byte ptr [ecx+2], al // shift and incorporate next bits mov eax, dword ptr [EPCMgr] shr eax, 6 mov ecx, dword ptr [EPC] mov byte ptr [ecx+3], al // shift and incorporate next bits mov eax, dword ptr [EPCMgr] shl eax, 2 mov ecx, dword ptr [EPC] mov byte ptr [ecx+4], al movzx eax, byte ptr [indicatorDigit] imul eax, eax, 186A0h mov ecx, dword ptr [ObjectClass] add ecx, eax mov dword ptr [ObjectClass], ecx // shift and incorporate high bits mov eax, dword ptr [ObjectClass] shr eax, 0Ah mov ecx, dword ptr [EPC] mov byte ptr [ecx+5], al // shift and incorporate next bits mov eax, dword ptr [ObjectClass] shr eax, 2 mov ecx, dword ptr [EPC] mov byte ptr [ecx+6], al // shift and incorporate last bits mov eax, dword ptr [ObjectClass] shl eax, 6 mov ecx, dword ptr [EPC] mov byte ptr [ecx+7], al // bits are already aligned mov eax, dword ptr [serialNumber] movzx eax, byte ptr [eax] mov ecx, dword ptr [EPC] movzx ecx, byte ptr [ecx+7] or ecx, eax mov eax, dword ptr [EPC] mov byte ptr [eax+7], cl // bits are already aligned mov eax, dword ptr [EPC] mov ecx, dword ptr [serialNumber] mov cl, byte ptr [ecx+1] mov byte ptr [eax+8], cl // bits are already aligned mov eax, dword ptr [EPC] mov ecx, dword ptr [serialNumber] mov cl, byte ptr [ecx+2] mov byte ptr [eax+9], cl // bits are already aligned mov eax, dword ptr [EPC] mov ecx, dword ptr [serialNumber] mov cl, byte ptr [ecx+3] mov byte ptr [eax+0Ah], cl // bits are already aligned mov eax, dword ptr [EPC] mov ecx, dword ptr [serialNumber] mov cl, byte ptr [ecx+4] mov byte ptr [eax+0Bh], cl pop edi pop esi pop ebx add esp, 0D8h cmp ebp, esp call @ILT+925(_{——}RTC_CheckEsp) (4113A2h) leave ret.

1. A method and apparatus for converting or translating descriptions of products encoded in the Universal Product Code (UPC) or Uniform Code Council 12 (UCC-12) format to the Electronic Product Code (EPC) format comprising:
a means of loading and storing registers;
and a means of multiplying, dividing, shifting or adding register contents.

2. A method according to claim 1 wherein the operation of storage of a register involves only shift operations.

3. A method according to claim 1 wherein the operation of storage of a register involves only multiplication or division operations.

4. A method according to claim 1 wherein the operation of storage of a register involves a mix of multiplication, division, or shift operations.

5. A method according to claim 1 wherein the entire operation of the method or parts of it are embodied within digital logic gates.

6. A method according to claim 1 wherein the entire operations of the method or parts of it are embodied within a Hamiltonian or other matrix operation.

7. A method according to claim 1 wherein all values to be incorporated into the resulting EPC code are extracted from input and from the UPC code before being incorporated, via a single bit-field storage command into the target EPC storage range.
